(19) United States
(12) Patent Application Publication
(10) Pub. No.: US 2025/0385037 A1
(43) Pub. Date: Dec. 18, 2025

(54) INDUCTOR AND METHOD FOR MANUFACTURING THE SAME

(71) Applicant: CHILISIN ELECTRONICS CORP., Taoyuan City (TW)

(72) Inventor: Chun-Chih LIN, Hsinchu County (TW)

(21) Appl. No.: 19/221,556

(22) Filed: May 29, 2025

Related U.S. Application Data
(60) Provisional application No. 63/659,343, filed on Jun. 13, 2024.

(30) Foreign Application Priority Data
Dec. 25, 2024 (TW) 113150748

(51) Int. Cl. H01F 27/28; H01F 27/29; H01F 27/32; H01F 41/063; H01F 41/12

(52) U.S. Cl. CPC H01F 27/2823; H01F 27/292; H01F 27/32; H01F 41/063; H01F 41/125

(57) ABSTRACT

An inductor includes a magnetic body, coil set, and electrode structure. The magnetic body has a mounting surface, and first and second opposite end surfaces. The magnetic body includes first and second positioning portions protruding from the first and second end surfaces. Each coil set includes first and second conductors buried in the magnetic body. The first conductor includes first and second outer protruding portions on the first and second positioning portions. The second conductor is electrically isolated from and coiled within the first conductor. The second conductor includes first and second opposite inner protruding portions. Bottom surfaces of the first and second outer protruding portions and the first and second inner protruding portions are in the mounting surface. Each electrode structure includes two first and second electrodes on the bottom surfaces of the first and second outer protruding portions, and the first and second inner protruding portions.

### CROSS-REFERENCE TO RELATED APPLICATION

This application claims priority to U.S. Provisional Application Ser. No. 63/659,343, filed Jun. 13, 2024 and Taiwan Application Serial Number 113150748, filed Dec. 25, 2024, which are herein incorporated by reference in their entirety.

### BACKGROUND

### Field of Invention

The present disclosure relates to an electronic device, and more particularly, to an inductor and a method for manufacturing the same.

### Description of Related Art

Typically, in the manufacturing of a trans-inductor voltage regulator, two magnetic structures are first formed by pre-sintering, and then the two magnetic structures and two conductors are assembled by bonding. Such a manufacturing method requires dispensing glue on side walls of the magnetic structures, assembling and bonding the two conductors to the magnetic structures, and then docking and packaging the two magnetic structures.

However, such a procedure makes it difficult to automate production. In addition, the product made by such assembly has low structural strength. Furthermore, the production method has a temperature restriction in the selection of materials, which limits the characteristics of the product.

### SUMMARY

Therefore, one objective of the present disclosure is to provide an inductor and a method for manufacturing the same, which presses and combines a magnetic body and two conductors to form an integrated structure through molding, such that it can increase the structural strength of the product, facilitate the miniaturization of the product, and greatly enhance the degree of production automation.

Another objective of the present disclosure is to provide an inductor and a method for manufacturing the same, which provides grooves in a molding space of a mold to position two conductors, such that it can solve the problem of misalignment of the conductors in all directions and prevent deviations from occurring in product characteristics, thereby enhancing product characteristics.

According to the aforementioned objectives, the present disclosure provides an inductor, which includes a magnetic body, at least one coil set, and at least one electrode structure. The magnetic body has a mounting surface, and a first end surface and a second end surface that are opposite to each other. The magnetic body includes a first positioning portion and a second positioning portion respectively protruding from the first end surface and the second end surface. Each coil set includes a first conductor and a second conductor. The first conductor is buried in the magnetic body. The first conductor includes a first outer protruding portion and a second outer protruding portion, which are opposite to each other and are respectively positioned on the first positioning portion and the second positioning portion. A bottom surface of the first outer protruding portion and a bottom surface of the second outer protruding portion are located in the mounting surface. The second conductor is buried in the magnetic body, electrically isolated from the first conductor, and coiled within the first conductor. The second conductor includes a first inner protruding portion and a second inner protruding portion that are opposite to each other. A bottom surface of the first inner protruding portion and a bottom surface of the second inner protruding portion are located in the mounting surface. The at least one electrode structure is disposed on the mounting surface of the magnetic body and respectively corresponds to the at least one coil set. Each electrode structure includes two first electrodes re and two second electrodes. The two first electrodes are respectively disposed on the bottom surface of the first outer protruding portion and the bottom surface of the second outer protruding portion. The two second electrodes are respectively disposed on the bottom surface of the first inner protruding portion and the bottom surface of the second inner protruding portion.

According to one embodiment of the present disclosure, the first conductor is covered with a first insulating layer, and the first insulating layer does not cover the bottom surface of the first outer protruding portion and the bottom surface of the second outer protruding portion. The second conductor is covered with a second insulating layer, and the second insulating layer does not cover the bottom surface of the first inner protruding portion and the bottom surface of the second inner protruding portion.

According to one embodiment of the present disclosure, the inductor further includes a third insulating layer covering a portion of the magnetic body and exposing portions of the mounting surface to expose the first outer protruding portion, the second outer protruding portion, the first inner protruding portion, and the second inner protruding portion.

According to one embodiment of the present disclosure, a side surface of the first outer protruding portion is exposed in the first positioning portion, and a side surface of the second outer protruding portion is exposed in the second positioning portion.

According to one embodiment of the present disclosure, the first positioning portion and the second positioning portion respectively protrude from the first end surface and the second end surface by a distance ranging from 0.05 mm to 1.0 mm.

According to one embodiment of the present disclosure, the magnetic body has a first direction and a second direction that are perpendicular to each other, and a number of each the at least one coil set and the at least one electrode structure is plural. The coil sets are arranged spaced apart from each other in the first direction, and the adjacent coil sets in the first direction have a first minimum separation distance in the first direction.

According to one embodiment of the present disclosure, the magnetic body has a first direction and a second direction that are perpendicular to each other, and a number of each the at least one coil set and the at least one electrode structure is plural. The coil sets are arranged spaced apart from each other in the second direction, and the adjacent coil sets in the second direction have a second minimum separation distance in the second direction.

According to one embodiment of the present disclosure, the magnetic body has a first direction and a second direction that are perpendicular to each other, and a number of each the at least one coil set and the at least one electrode structure is plural. The coil sets are arranged spaced apart from each other in the first direction and the second direction. The adjacent coil sets in the first direction have a first minimum separation distance in the first direction. The adjacent coil sets in the second direction have a second minimum separation distance in the second direction.

According to the aforementioned objectives, the present disclosure further provides a method foe manufacturing an inductor. In this method, a first conductor and a second conductor are combined, such that the second conductor is electrically isolated from the first conductor and coiled within the first conductor. The first conductor includes a first outer protruding portion and a second outer protruding portion that are opposite to each other. The second conductor includes a first inner protruding portion and a second inner protruding portion that are opposite to each other. A first magnetic material is placed into a mold space of a mold. The mold includes a first positioning post and a second positioning post opposite to each other and protruding in the mold space to define a first groove and a second groove in the mold space. The combined first conductor and second conductor are placed on the first magnetic material, and the first outer protruding portion and the second outer protruding portion are positioned in the first groove and the second groove respectively. A second magnetic material is placed into the mold space to cover the first magnetic material, the first conductor, and the second conductor. A pressing operation is performed to press the first magnetic material and the second magnetic material to form a magnetic body, and to bury a combination of the first conductor and the second conductor in the magnetic body. The first outer protruding portion, the second outer protruding portion, the first inner protruding portion, and the second inner protruding portion are exposed in a mounting surface of the magnetic body. Two first electrodes are formed to cover the first outer protruding portion and the second outer protruding portion in the mounting surface respectively. Two second electrodes are formed to cover the first inner protruding portion and the second inner protruding portion in the mounting surface respectively.

According to one embodiment of the present disclosure, before combining the first conductor and the second conductor, the method further includes: performing a surface insulation treatment on the first conductor and the second conductor to form a first insulating layer to cover the first conductor, and a second insulating layer to cover the second conductor; and removing the first insulating layer on a bottom surface of the first outer protruding portion and a bottom surface of the second outer protruding portion, and removing the second insulating layer on a bottom surface of the first inner protruding portion and a bottom surface of the second inner protruding portion.

According to one embodiment of the present disclosure, the first conductor is in an inverted U shape, and combining the first conductor and the second conductor includes engaging the second conductor within the first conductor.

According to one embodiment of the present disclosure, a width of each of the first positioning post and the second positioning post is ranging from 0.05 mm to 1.0 mm.

According to one embodiment of the present disclosure, the first magnetic material is a preformed magnetic body.

According to one embodiment of the present disclosure, the second magnetic material is a magnetic powder material.

According to one embodiment of the present disclosure, the second magnetic material is a preformed magnetic body.

According to one embodiment of the present disclosure, the pressing operation is a hot pressing operation, and performing the hot pressing operation includes performing a heating treatment.

According to one embodiment of the present disclosure, the pressing operation is a cold pressing operation, and the pressing operation is performed at room temperature.

According to one embodiment of the present disclosure, after performing the pressing operation, the method further includes: performing a spraying operation to form a third insulating layer to cover the magnetic body; and removing portions of the third insulating layer to expose the first outer protruding portion, the second outer protruding portion, the first inner protruding portion, and the second inner protruding portion in the mounting surface.

### BRIEF DESCRIPTION OF THE DRAWINGS

Aspects of the present disclosure are best understood from the following detailed description in conjunction with the accompanying figures. It is noted that in accordance with the standard practice in the industry, various features are not drawn to scale. In fact, dimensions of the various features can be arbitrarily increased or reduced for clarity of discussion.

FIG. 1 is a schematic three-dimensional diagram of an inductor in accordance with one embodiment of the present disclosure.

FIG. 2 is a schematic three-dimensional perspective diagram of an inductor in accordance with one embodiment of the present disclosure.

FIG. 3 is a schematic bottom perspective view of an inductor in accordance with one embodiment of the present disclosure.

FIG. 4 through FIG. 10 are schematic diagrams of various stages in a method for manufacturing an inductor in accordance with one embodiment of the present disclosure.

FIG. 11 is a schematic three-dimensional perspective diagram of an inductor in accordance with another embodiment of the present disclosure.

FIG. 12 is a schematic three-dimensional perspective diagram of an inductor in accordance with still another embodiment of the present disclosure.

### DETAILED DESCRIPTION

The embodiments of the present disclosure are discussed in detail below. However, it will be appreciated that the embodiments provide many applicable concepts that can be implemented in various specific contents. The embodiments discussed and disclosed are for illustrative purposes only and are not intended to limit the scope of the present disclosure. All of the embodiments of the present disclosure disclose various different features, and these features may be implemented separately or in combination as desired.

In addition, the terms “first”, “second”, and the like, as used herein, are not intended to mean a sequence or order, and are merely used to distinguish elements or operations described in the same technical terms.

The spatial relationship between two elements described in the present disclosure applies not only to the orientation depicted in the drawings, but also to the orientations not represented by the drawings, such as the orientation of the inversion. Moreover, the terms “connected”, “electrically connected”, or the like between two components referred to in the present disclosure are not limited to the direct connection or electrical connection of the two components, and may also include indirect connection or electrical connection as required.

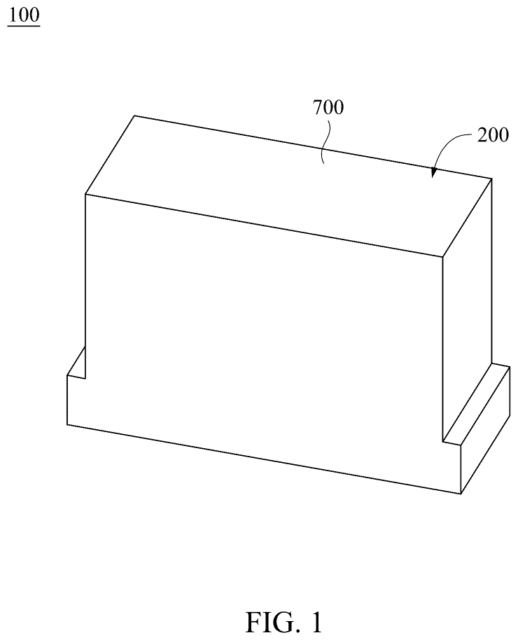

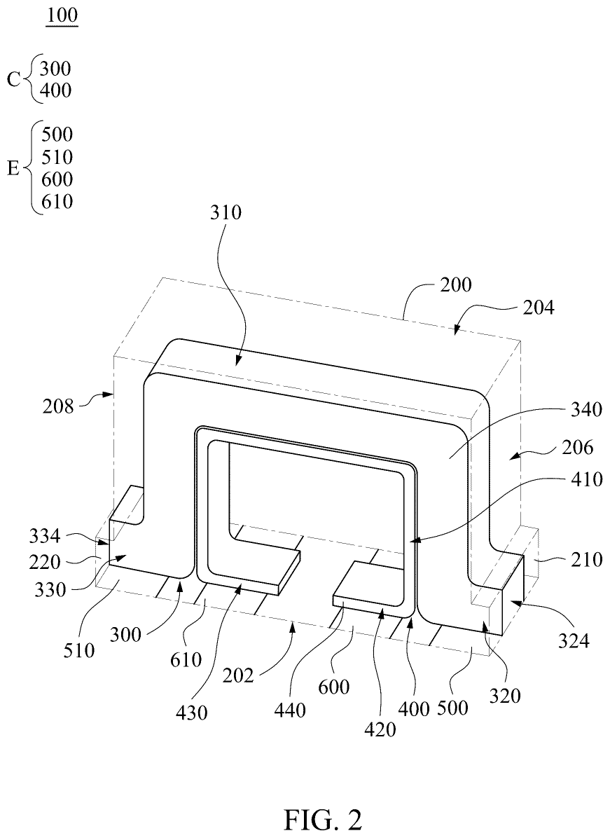

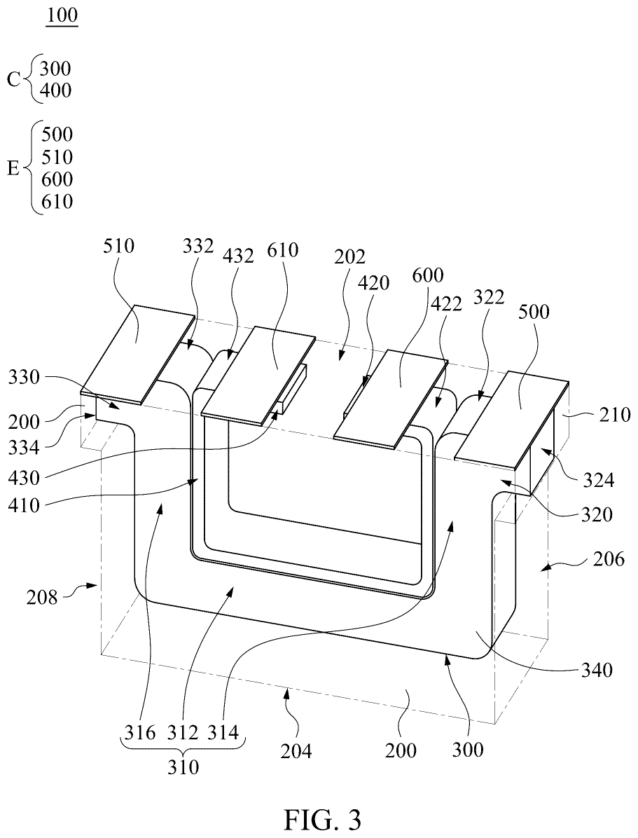

Referring to FIG. 1 through FIG. 3, FIG. 1 through FIG. 3 respectively illustrate a schematic three-dimensional diagram, a schematic three-dimensional perspective diagram, and a schematic bottom perspective view of an inductor 100 in accordance with one embodiment of the present disclosure. In order to clearly illustrate internal components of the inductor 100, an insulating layer on a surface of the inductor 100 is omitted in FIG. 2 and FIG. 3. The inductor 100 can be applied in a circuit buck-boost converter and a DC-to-DC converter. The inductor 100 may mainly include a magnetic body 200, a coil set C, and an electrode structure E. The coil set C includes a first conductor 300 and a second conductor 400. The electrode structure E includes two first electrodes 500 and 510 and two second electrodes 600 and 610.

The magnetic body 200 is a structure made from a magnetic material. The magnetic material may include a binder and at least one of crystalline magnetic metal powder and amorphous magnetic metal powder. For example, the crystalline metal magnetic powder may be iron silicon (Fe—Si), iron silicon chromium (Fe—Si—Cr), iron silicon aluminum (Fe—Si—Al), iron nickel (Fe—Ni), carbonyl iron powder (CIP), iron (Fe), iron-nickel-molybdenum (Fe—Ni—Mo), iron-cobalt-vanadium (Fe—Co—V), including but not limited to the above materials. The amorphous metal magnetic powder may be Fe-based amorphous magnetic metal power, such as iron silicon boron carbon (FeSiBC), iron silicon chromium boron phosphorus carbon (FeSiCrBPC), including but not limited to the above materials.

For example, the magnetic body 200 may be a cuboid structure. According to the product design, the magnetic body 200 may be a block structure of other shapes, such as a cube structure, and the present disclosure is not limited thereto. In the example shown in FIG. 2, the magnetic body 200 has a mounting surface 202, an upper surface 204 that is opposite to the mounting surface 202, and a first end surface 206 and a second end surface 208 that are opposite to each other. The mounting surface 202 is the lower surface of the magnetic body 200, and the magnetic body 200 can be connected to an external electronic component, such as a circuit board, through the mounting surface 202. The first end surface 206 and the second end surface 208 are located on opposite sides of the mounting surface 202 and the upper surface 204, and the first end surface 206 and the second end surface 208 are both located between the mounting surface 202 and the upper surface 204.

The magnetic body 200 includes a first positioning portion 210 and a second positioning portion 220. The first positioning portion 210 protrudes from the first end surface 206 of the magnetic body 200, and the second positioning portion 220 protrudes from the second end surface 208. The first positioning portion 210 and the second positioning portion 220 are opposite to each other and may be adjacent to the mounting surface 202. In some examples, the first positioning portion 210 protrudes from the first end surface 206 by a distance ranging from 0.05 mm to 1.0 mm, and the second positioning portion 220 protrudes from the second end surface 208 by a distance ranging from 0.05 mm to 1.0 mm. In a preferred example, each of the distances is equal to or smaller than 0.5 mm. The first positioning portion 210 and the second positioning portion 220 can be used to position the first conductor 300.

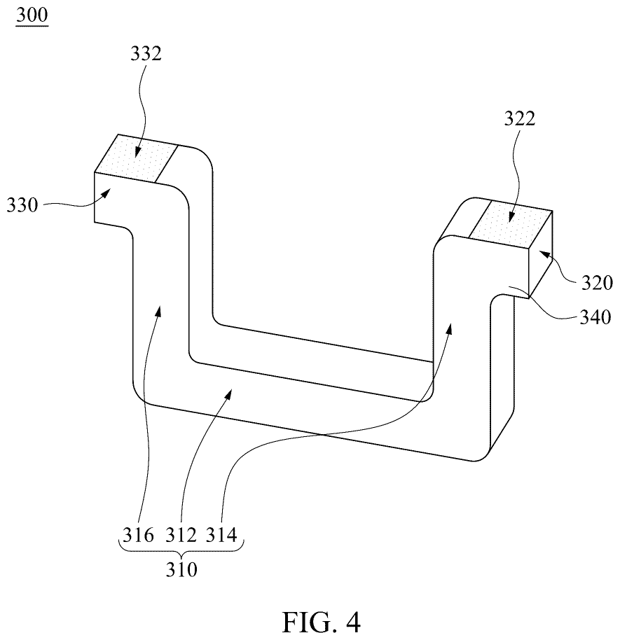

As shown in FIG. 2 and FIG. 3, the first conductor 300 is buried in the magnetic body 200. Referring to FIG. 4 simultaneously, FIG. 4 is a schematic three-dimensional diagram of the first conductor 300. As shown in FIG. 2, the first conductor 300 may be in an inverted U shape. Specifically, the first conductor 300 includes a main body 310, a first outer protruding portion 320, and a second outer protruding portion 330. The main body 310 includes a first portion 312, a second portion 314, and a third portion 316, in which the second portion 314 and the third portion 316 are opposite to each other and connected to two opposite ends of the first portion 312. The first outer protruding portion 320 is connected to the other end of the second portion 314 that is opposite to the first portion 312. The second outer protruding portion 330 is connected to the other end of the third portion 316 opposite to the first portion 312. Furthermore, the first outer protruding portion 320 and the second outer protruding portion 330 respectively extend in directions away from each other and are opposite to each other.

When the first conductor 300 is buried in the magnetic body 200, the first outer protruding portion 320 and the second outer protruding portion 330 are respectively positioned on the first positioning portion 210 and the second positioning portion 220 of the magnetic body 200. In addition, as shown in FIG. 3, a bottom surface 322 of the first outer protruding portion 320 and a bottom surface 332 of the second outer protruding portion 330 are located in the mounting surface 202 of the magnetic body 200. That is, the bottom surface 322 of the first outer protruding portion 320 and the bottom surface 332 of the second outer protruding portion 330 are exposed in the magnetic body 200. In some examples, a side surface 324 of the first outer protruding portion 320 is exposed in the first positioning portion 210, and a side surface 334 of the second outer protruding portion 330 is exposed in the second positioning portion 220.

For example, a material of the first conductor 300 may be copper. The first conductor 300 is covered with a first insulating layer 340 to electrically isolate the first conductor 300 and the second conductor 400. The first insulating layer 340 does not cover a portion of the bottom surface 322 of the first outer protruding portion 320 and a portion of the bottom surface 332 of the second outer protruding portion 330, such that the first conductor 300 can be electrically connected to an external device.

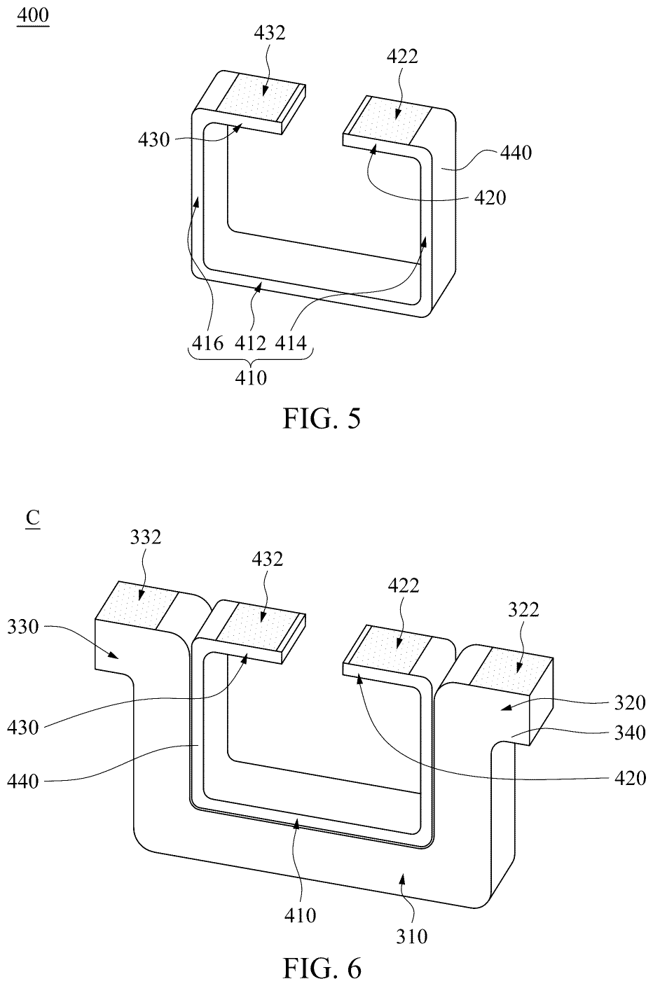

Referring to FIG. 5 simultaneously, FIG. 5 is a schematic three-dimensional diagram of the second conductor 400. For example, the second conductor 400 may include a main body 410, a first inner protruding portion 420, and a second inner protruding portion 430. As shown in FIG. 2, the main body 410 may be in an inverted U shape. Specifically, as shown in FIG. 5, the main body 410 includes a first portion 412, a second portion 414, and a third portion 416, in which the second portion 414 and the third portion 416 are opposite to each other and are connected to two opposite ends of the first portion 412. The first inner protruding portion 420 is connected to the second portion 414, and the first inner protruding portion 420 and the first portion 412 are respectively located on two opposite ends of the second portion 414. The second inner protruding portion 430 is connected to the third portion 416, and the second inner protruding portion 430 and the first portion 412 are respectively located on two opposite ends of the third portion 416. In addition, the first inner protruding portion 420 and the second inner protruding portion 430 respectively extend toward each other, and are opposite to and separated from each other.

As shown in FIG. 2 and FIG. 3, the second conductor 400 is similarly buried in the magnetic body 200. When the second conductor 400 is buried in the magnetic body 200, a bottom surface 422 of the first inner protruding portion 420 and a bottom surface 432 of the second inner protruding portion 430 are located in the mounting surface 202 of the magnetic body 200. Therefore, the bottom surface 422 of the first inner protruding portion 420 and the bottom surface 432 of the second inner protruding portion 430 are exposed in the magnetic body 200.

Referring to FIG. 6, FIG. 6 is a schematic three-dimensional diagram of the combination of the first conductor 300 and the second conductor 400. The second conductor 400 is electrically isolated from and coiled inside the first conductor 300 to form the coil set C with the first conductor 300. For example, the main body 410 of the second conductor 400 may be disposed in the space defined by the main body 310 of the first conductor 300 by an engagement method. The first portion 412, the second portion 414, and the third portion 416 of the main body 410 of the second conductor 400 are respectively adjacent to the first portion 312, the second portion 314, and the third portion 316 of the main body 310 of the first conductor 300.

For example, a material of the second conductor 400 may be copper. The second conductor 400 is covered with a second insulating layer 440, such that the second conductor 400 is electrically isolated from the first conductor 300. The second insulating layer 440 does not cover the bottom surface 422 of the first inner protruding portion 420 and the bottom surface 432 of the second inner protruding portion 430 to facilitate electrical connection between the second conductor 400 and an external device.

As shown in FIG. 1, in some examples, the inductor 100 further includes a third insulating layer 700. The third insulating layer 700 covers a portion of the magnetic body 200. The material of the magnetic body 200 includes iron powder, such that the third insulating layer 700 is used to cover the magnetic body 200 to prevent the magnetic body 200 from rusting. The third insulating layer 700 exposes portions of the mounting surface 202 of the magnetic body 200 to expose the bottom surface 322 of the first outer protruding portion 320, the bottom surface 332 of the second outer protruding portion 330, the bottom surface 422 of the first inner protruding portion 420, and the bottom surface 432 of the second inner protruding portion 430, such that the first conductor 300 and the second conductor 400 can be electrically connected to an external device. A material of the third insulating layer 700 may be an organic polymer material or an inorganic polymer material. For example, the material of the third insulating layer 700 may be epoxy resin, acrylic resin, and silicone, but the present disclosure is not limited thereto.

The electrode structure E is disposed on the mounting surface 202 of the magnetic body 200 and corresponds to the coil set C. As shown in FIG. 3, the first electrode 500 is disposed on the bottom surface 322 of the first outer protruding portion 320 of the first conductor 300, and the first electrode 510 is disposed on the bottom surface 332 of the second outer protruding portion 330. The second electrode 600 is disposed on the bottom surface 422 of the first inner protruding portion 420 of the second conductor 400, and the second electrode 610 is disposed on the bottom surface 432 of the second inner protruding portion 430. The first conductor 300 can receive current from an external device through the first electrodes 500 and 510. On the other hand, the second conductor 400 can receive current from the external device through the second electrodes 600 and 610. In some examples, each of the first electrodes 500 and 510 and the second electrodes 600 and 610 may include a copper layer, a nickel layer, and a tin layer, and the copper layers, the nickel layers, and the tin layers are sequentially stacked on the first outer protruding portion 320 and the second outer protruding portion 330 of the first conductor 300 and the first inner protruding portion 420 and the second inner protruding portion 430 of the second conductor 400 correspondingly.

The first positioning portion 210 and the second positioning portion 220 of the magnetic body 200 can position the first outer protruding portion 320 and the second outer protruding portion 330 of the first conductor 300, thereby positioning the combination of the first conductor 300 and the second conductor 400. Therefore, the alignment of the first conductor 300 and the second conductor 400 in all directions can be improved, such that the characteristics of the inductor 100 can be prevented from being deviated, thereby enhancing the characteristics of the inductor 100.

Referring to FIG. 4 through FIG. 10, FIG. 4 through FIG. 10 are schematic diagrams of various stages in a method for manufacturing an inductor 100 in accordance with one embodiment of the present disclosure. In the manufacturing the inductor 100, the first conductor 300 as shown in FIG. 4 and the second conductor 400 as shown in FIG. 5 may be first combined to dispose the second conductor 400 within the main body 310 of the first conductor 300 by using, for example, an engagement method to form the coil set C, as shown in FIG. 6. The main body 410, the first inner protruding portion 420, and the second inner protruding portion 430 of the second conductor 400 are coiled inside the main body 310 of the first conductor 300.

The second conductor 400 and the first conductor 300 are electrically isolated from each other. In some examples, before combining the first conductor 300 and the second conductor 400, a surface insulation treatment is first performed on the first conductor 300 and the second conductor 400 to form a first insulating layer 340 to cover the first conductor 300 and a second insulating layer 440 to cover the second conductor 400. After the first insulating layer 340 and the second insulating layer 440 are formed, the first insulating layer 340 on the bottom surface 322 of the first outer protruding portion 320 and the bottom surface 332 of the second outer protruding portion 330 of the first conductor 300, and the second insulating layer 440 on the bottom surface 422 of the first inner protruding portion 420 and the bottom surface 432 of the second inner protruding portion 430 of the second conductor 400 may be removed by using a laser or a mechanical means. Thus, the first conductor 300 and the second conductor 400 are electrically isolated from each other, and the first conductor 300 and the second conductor 400 can be electrically connected to an external device. In an example that the first conductor 300 and the second conductor 400 are, for example, enameled wires, the aforementioned surface insulation treatment and the step of removing portions of the insulating layers can be omitted.

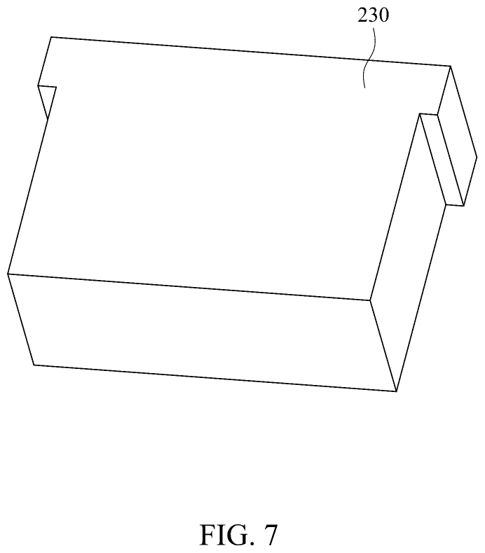

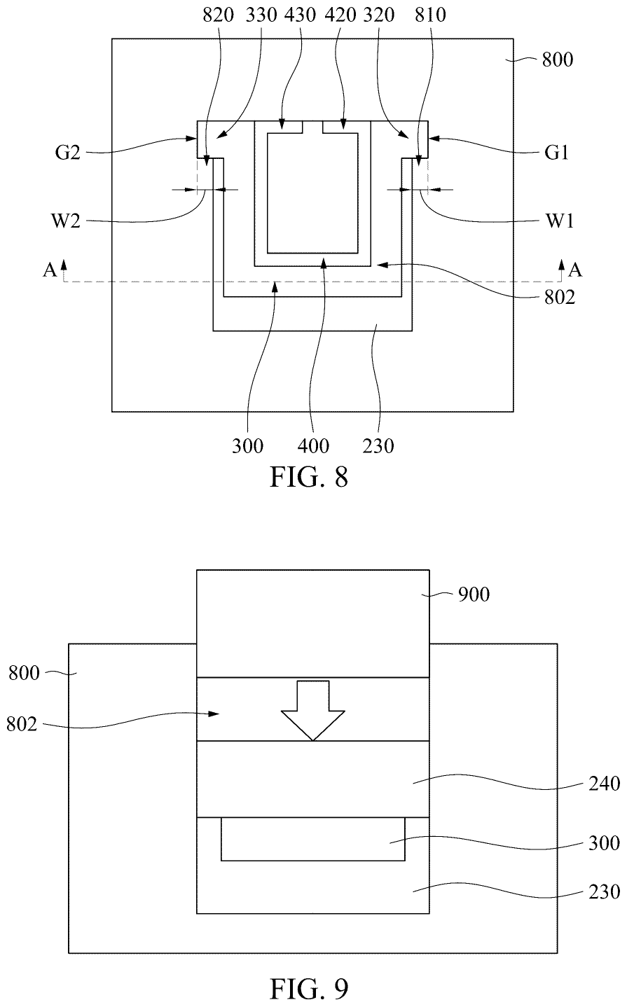

Next, referring to FIG. 7 and FIG. 8, a first magnetic material 230 is prepared and placed into a mold space 802 of a mold 800. As shown in FIG. 8, which is viewed from the top of the mold 800, the mold 800 includes a first positioning post 810 and a second positioning post 820. The first positioning post 810 and the second positioning post 820 protrude into the mold space 802 and are opposite to each other. In some examples, a width W1 of the first positioning post 810 and a width W2 of the second positioning post 820 are ranging from 0.05 mm to 1.0 mm. In a preferred example, each of the width W1 and the width W2 is equal to or smaller than 0.5 mm. The first positioning post 810 and the second positioning post 820 define a first groove G1 and a second groove G2 in the mold space 802. The first groove G1 and the second groove G2 are respectively located above the first positioning post 810 and the second positioning post 820 and opposite to each other.

For example, the first magnetic material 230 may be a preformed magnetic body, which has a shape and a size corresponding to those of the mold space 802 of the mold 800. However, the first magnetic material 230 may be other forms of materials, such as magnetic powder. In the example that the first magnetic material 230 is a preformed magnetic body, the first magnetic material 230 is preformed according to the shape and the size of the mold space 802 of the mold 800. The shape of the first magnetic material 230 is the same as the shape of the mold space 802, but the size of the first magnetic material 230 is slightly smaller than the size of the mold space 802, such that the first magnetic material 230 can be correspondingly embedded in the mold space 802 of the mold 800. The preformed first magnetic material 230 can provide the first conductor 300 and the second conductor 400 with a stronger structural support during a subsequent die casting process.

Then, as shown in FIG. 8, the pre-combined first conductor 300 and the second conductor 400 are placed on the first magnetic material 230 in the mold space 802. The first outer protruding portion 320 and the second outer protruding portion 330 of the first conductor 300 are respectively located on the first positioning post 810 and the second positioning post 820, such that the first outer protruding portion 320 and the second outer protruding portion 330 are respectively positioned in the first groove G1 and the second groove G2.

Referring to FIG. 9, FIG. 9 is a schematic cross-sectional view of the first magnetic material 230, the first conductor 300, and a second magnetic material 240 during a pressing operation. FIG. 9 is a schematic cross-sectional view taken along a section line A-A in FIG. 8. Next, the second magnetic material 240 is placed into the mold space 802 to cover the combination of the first conductor 300 and the second conductor 400 and the first magnetic material 230. For example, the composition of the second magnetic material 240 may be the same as the composition of the first magnetic material 230. In some examples, the second magnetic material 240 is a magnetic powder material, in which the second magnetic material 240 is filled into the second conductor 400.

In other examples, the second magnetic material 240 is a preformed magnetic body, which is formed according to the shape and the size of the mold space 802 of the mold 800. The preformed second magnetic material 240 may be a simple flat plate structure having a flat upper surface and a flat lower surface, or a plate structure having a flat upper surface and a protruding structure protruding from a lower surface that can be embedded into the second conductor 400. When the preformed second magnetic material 240 is a simple flat plate structure, a powdery magnetic material or a preformed block magnetic material may be first filled into the inside of the second conductor 400 according to the requirements of the pressing operation.

As shown in FIG. 9, after the second magnetic material 240 is filled into the mold space 802, an upper punch 900 may be used to perform a pressing operation on the first magnetic material 230, the second magnetic material 240, and the combination of the first conductor 300 and the second conductor 400 in the mold space 802 of the mold 800. The pressing operation can press and combine the first magnetic material 230 and the second magnetic material 240 to form the magnetic body 200 and to bury the combination of the first conductor 300 and the second conductor 400 in the magnetic body 200. The magnetic body 200, and the first conductor 300 and the second conductor 400 buried therein are taken out from the mold 800. The first outer protruding portion 320 and the second outer protruding portion 330 of the first conductor 300 and the first inner protruding portion 420 and the second inner protruding portion 430 of the second conductor 400 are exposed in the mounting surface 202 of the magnetic body 200.

In some examples, the pressing operation is a hot pressing operation. Therefore, when performing the hot pressing operation, a heating platform may be used to simultaneously perform a heat treatment, for example. The first magnetic material 230 and the second magnetic material 240 may contain a binder and magnetic powder. Thus, when heating, the melting of the binder can make the magnetic powder fluid, which is beneficial to the molding of the magnetic body 200. In other examples, the pressing operation is a cold pressing operation, and the pressing operation is performed at room temperature.

Combining the magnetic body 200, the first conductor 300, and the second conductor 400 through molding allows for a wider selection of magnetic materials and a high degree of automation. In addition, the molding method can produce the inductor 100 with a smaller volume, which is beneficial to the miniaturization of the product. Furthermore, the combination of the magnetic body 200 with the first conductor 300 and the second conductor 400 is more secure, which can enhance the performance of the inductor 100. Moreover, the first groove G1 and the second groove G2 of the mold 800 can accurately position the combination of the first conductor 300 and the second conductor 400, thereby further enhancing the characteristics of the inductor 100.

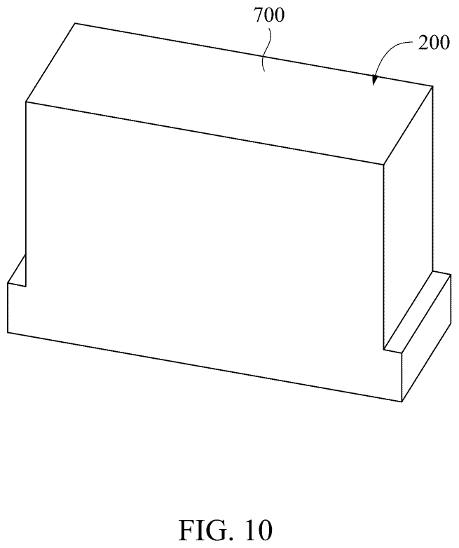

As shown in FIG. 10, after the pressing operation, a spraying operation may be performed on the magnetic body 200 to form a third insulating layer 700 to cover the magnetic body 200, so as to prevent the magnetic body 200 from rusting. After completing the spraying of the third insulating layer 700, portions of the third insulating layer 700 are removed by using, for example, a laser or a mechanical means to expose the first outer protruding portion 320 and the second outer protruding portion 330 of the first conductor 300 and the first inner protruding portion 420 and the second inner protruding portion 430 of the second conductor 400 located in the mounting surface 202 of the magnetic body 200.

Then, for example, an electroplating method may be used to form a first electrode 500 to cover the first outer protruding portion 320 in the mounting surface 202, and a first electrode 510 to cover the second outer protruding portion 330 in the mounting surface 202. Similarly, for example, an electroplating method may be used to form a second electrode 600 to cover the first inner protruding portion 420 in the mounting surface 202, and a second electrode 610 to cover the second inner protruding portion 430 in the mounting surface 202, so as to complete the inductor 100 as shown in FIG. 2 and FIG. 3.

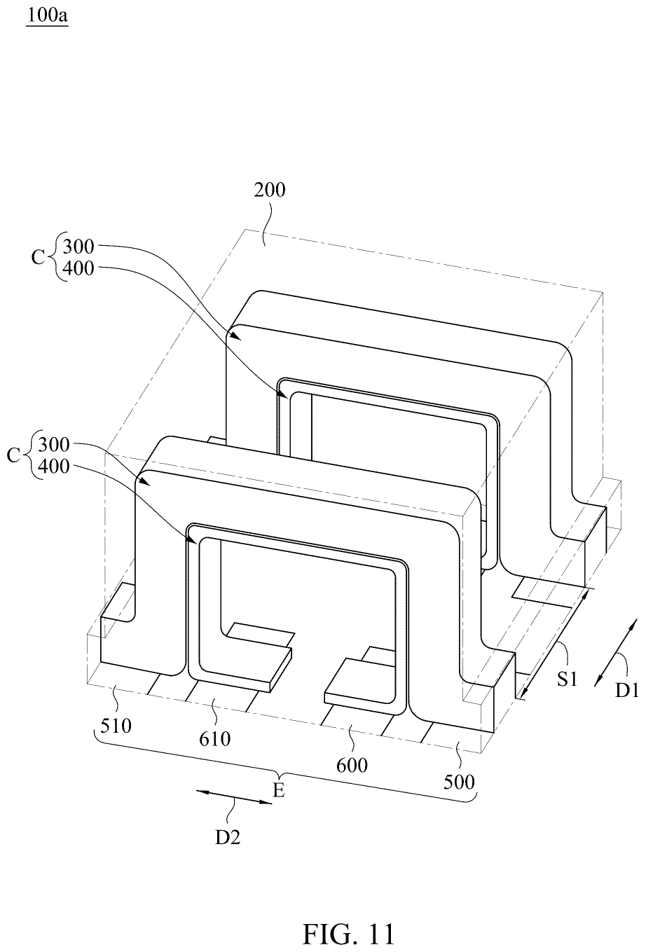

In other examples, the inductor may include plural coil sets and a corresponding number of electrode structures, which is not limited to the above embodiment. Referring to FIG. 11, FIG. 11 is a schematic three-dimensional perspective diagram of an inductor 100a in accordance with another embodiment of the present disclosure. The structure of the inductor 100a is substantially the same as that of the aforementioned inductor 100. The difference between the inductors 100a and 100 is that the inductor 100a includes plural coil sets C and plural corresponding electrode structures E. The connection between each of the coil sets C and the corresponding electrode structure E is as that described in the above embodiment, and will not be repeated herein.

Specifically, the magnetic body 200 has a first direction D1 and a second direction D2, which are perpendicular to each other. For example, the first direction D1 and the second direction D2 may be respectively an X-axis direction and a Y-axis direction on an XY plane, which is parallel to the mounting surface 202 of the magnetic body 200. Therefore, the first direction D1 and the second direction D2 are perpendicular to each other. The coil sets C are arranged at intervals in the magnetic body 200 along the first direction D1. Accordingly, electromotive forces in the same direction can be generated between two adjacent ones of the coil sets C. The two adjacent ones of the coil sets C in the first direction D1 have a first minimum separation distance S1 in the first direction D1. For example, the first minimum separation distance S1 may be ranging from 0.01 mm to 10 mm to prevent unexpected voltage or current changes between the two adjacent ones of the coil sets C. In some preferred examples, the first minimum separation distance S1 is ranging from 0.1 mm to 1 mm. The present disclosure is not limited thereto.

In the example shown in FIG. 11, the inductor 100a includes two coil sets C and two electrode structures E. However, the inductor 100a may include more than two coil sets C and electrode structures E arranged as that shown in FIG. 11, and the present disclosure is not limited thereto.

The coil sets C of the inductor 100a are arranged at intervals in the first direction D1. However, the present disclosure is not limited to the arrangement of the inductor 100a, and the coil sets C can also be arranged at intervals in the second direction D2 and/or the first direction D1. That is, the coil sets C may be arranged at intervals in the second direction D2, or in the second direction D2 and the first direction D1.

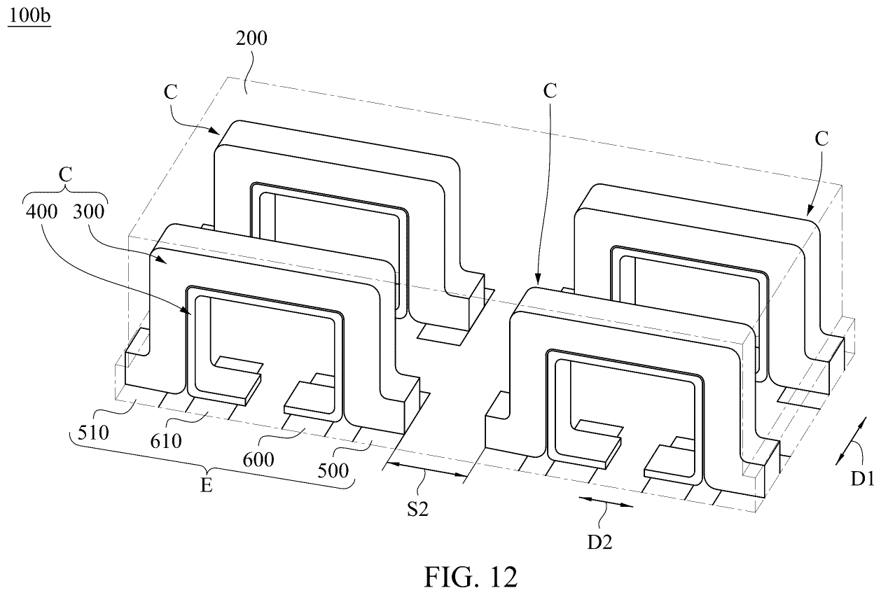

Referring to FIG. 12, FIG. 12 is a schematic three-dimensional perspective diagram of an inductor 100b in accordance with still another embodiment of the present disclosure. The structure of the inductor 100b is substantially the same as that of the aforementioned inductor 100a. The difference between the inductors 100b and 100a is that the inductor 100b includes plural coil sets C arranged along the first direction D1 and the second direction D2 and plural electrode structures E correspondingly connected to the coil sets C. The connection between each of the coil sets C and the corresponding electrode structure E is as that described in the above embodiment, and will not be repeated herein.

The coil sets C are arranged in the magnetic body 200 at intervals along the first direction D1 and the second direction D2. For example, the coil sets C are arranged in an array. Two adjacent ones of the coil sets C in the first direction D1 have a first minimum separation distance S1 in the first direction D1, and two adjacent ones of the coil sets C in the second direction D2 have a second minimum separation distance S2 in the second direction D2. For example, the second minimum separation distance S2 may be fringing from 0.01 mm to 10 mm to prevent unexpected voltage or current changes between the two adjacent ones of the coil sets C. In some preferred examples, the second minimum separation distance S2 is ranging from 0.1 mm to 1 mm. The first minimum separation distance S1 may be greater than, equal to, or smaller than the second minimum separation distance S2 depending on the design of the inductor 100b. The present disclosure is not limited thereto.

In the inductors 100a and 100b, through the design in which plural coil sets C are buried and arranged in the magnetic body 200 at intervals, and each of the coil sets C is connected to the corresponding electrode structure E, the inductors 100a and 100b can have higher power density in the same volume, thereby further enhancing power conversion efficiency.

According to the aforementioned embodiments, one advantage of the present disclosure is that the present disclosure presses and combines a magnetic body and two conductors to form an integrated structure through molding, such that it can increase the structural strength of the product, facilitate the miniaturization of the product, and greatly enhance the degree of production automation.

Another advantage of the present disclosure is that the present disclosure provides grooves in a molding space of a mold to position two conductors, such that it can solve the problem of misalignment of the conductors in all directions and prevent deviations from occurring in product characteristics, thereby enhancing product characteristics.

Although the present disclosure has been disclosed above with embodiments, it is not intended to limit the present disclosure. Any person having ordinary skill in the art can make various changes and modifications without departing from the spirit and scope of the present disclosure. Therefore, the protection scope of the present disclosure should be defined by the scope of the appended claims.

What is claimed is:

1. An inductor, comprising:
a magnetic body having a mounting surface, and a first end surface and a second end surface that are opposite to each other, wherein the magnetic body comprises a first positioning portion and a second positioning portion respectively protruding from the first end surface and the second end surface;
at least one coil set, wherein each of the at least one coil set comprises:
a first conductor buried in the magnetic body, wherein the first conductor comprises a first outer protruding portion and a second outer protruding portion, which are opposite to each other and are respectively positioned on the first positioning portion and the second positioning portion, and a bottom surface of the first outer protruding portion and a bottom surface of the second outer protruding portion are located in the mounting surface; and
a second conductor buried in the magnetic body, electrically isolated from the first conductor, and coiled within the first conductor, wherein the second conductor comprises a first inner protruding portion and a second inner protruding portion that are opposite to each other, and a bottom surface of the first inner protruding portion and a bottom surface of the second inner protruding portion are located in the mounting surface; and
at least one electrode structure disposed on the mounting surface of the magnetic body and respectively corresponding to the at least one coil set, wherein each of the at least one electrode structure comprises:
two first electrodes respectively disposed on the bottom surface of the first outer protruding portion and the bottom surface of the second outer protruding portion; and
two second electrodes respectively disposed on the bottom surface of the first inner protruding portion and the bottom surface of the second inner protruding portion.

2. The inductor of claim 1, wherein
the first conductor is covered with a first insulating layer, and the first insulating layer does not cover the bottom surface of the first outer protruding portion and the bottom surface of the second outer protruding portion; and
the second conductor is covered with a second insulating layer, and the second insulating layer does not cover the bottom surface of the first inner protruding portion and the bottom surface of the second inner protruding portion.

3. The inductor of claim 1, further comprising a third insulating layer covering a portion of the magnetic body and exposing portions of the mounting surface to expose the first outer protruding portion, the second outer protruding portion, the first inner protruding portion, and the second inner protruding portion.

4. The inductor of claim 1, wherein a side surface of the first outer protruding portion is exposed in the first positioning portion, and a side surface of the second outer protruding portion is exposed in the second positioning portion.

5. The inductor of claim 1, wherein the first positioning portion and the second positioning portion respectively protrude from the first end surface and the second end surface by a distance ranging from 0.05 mm to 1.0 mm.

6. The inductor of claim 1, wherein the magnetic body has a first direction and a second direction that are perpendicular to each other, a number of each the at least one coil set and the at least one electrode structure is plural, the coil sets are arranged spaced apart from each other in the first direction, and the adjacent coil sets in the first direction have a first minimum separation distance in the first direction.

7. The inductor of claim 1, wherein the magnetic body has a first direction and a second direction that are perpendicular to each other, a number of each the at least one coil set and the at least one electrode structure is plural, the coil sets are arranged spaced apart from each other in the second direction, and the adjacent coil sets in the second direction have a second minimum separation distance in the second direction.

8. The inductor of claim 1, wherein the magnetic body has a first direction and a second direction that are perpendicular to each other, a number of each the at least one coil set and the at least one electrode structure is plural, the coil sets are arranged spaced apart from each other in the first direction and the second direction, the adjacent coil sets in the first direction have a first minimum separation distance in the first direction, and the adjacent coil sets in the second direction have a second minimum separation distance in the second direction.

9. A method for manufacturing an inductor, comprising:
combining a first conductor and a second conductor, such that the second conductor is electrically isolated from the first conductor and coiled within the first conductor, wherein the first conductor comprises a first outer protruding portion and a second outer protruding portion that are opposite to each other, and the second conductor comprises a first inner protruding portion and a second inner protruding portion that are opposite to each other;
placing a first magnetic material into a mold space of a mold, wherein the mold comprises a first positioning post and a second positioning post opposite to each other and protruding in the mold space to define a first groove and a second groove in the mold space;
placing the combined first conductor and second conductor on the first magnetic material, and positioning the first outer protruding portion and the second outer protruding portion in the first groove and the second groove respectively;
placing a second magnetic material into the mold space to cover the first magnetic material, the first conductor, and the second conductor;
performing a pressing operation to press the first magnetic material and the second magnetic material to form a magnetic body, and bury a combination of the first conductor and the second conductor in the magnetic body, wherein the first outer protruding portion, the second outer protruding portion, the first inner protruding portion, and the second inner protruding portion are exposed in a mounting surface of the magnetic body;
forming two first electrodes to cover the first outer protruding portion and the second outer protruding portion in the mounting surface respectively; and
forming two second electrodes to cover the first inner protruding portion and the second inner protruding portion in the mounting surface respectively.

10. The method of claim 9, wherein before combining the first conductor and the second conductor, the method further comprises:
performing a surface insulation treatment on the first conductor and the second conductor to form a first insulating layer to cover the first conductor, and a second insulating layer to cover the second conductor; and
removing the first insulating layer on a bottom surface of the first outer protruding portion and a bottom surface of the second outer protruding portion, and removing the second insulating layer on a bottom surface of the first inner protruding portion and a bottom surface of the second inner protruding portion.

11. The method of claim 9, wherein the first conductor is in an inverted U shape, and combining the first conductor and the second conductor comprises engaging the second conductor within the first conductor.

12. The method of claim 9, wherein a width of each of the first positioning post and the second positioning post is ranging from 0.05 mm to 1.0 mm.

13. The method of claim 9, wherein the first magnetic material is a preformed magnetic body.

14. The method of claim 9, wherein the second magnetic material is a magnetic powder material.

15. The method of claim 9, wherein the second magnetic material is a preformed magnetic body.

16. The method of claim 9, wherein the pressing operation is a hot pressing operation, and performing the hot pressing operation comprises performing a heating treatment.

17. The method of claim 9, wherein the pressing operation is a cold pressing operation, and the pressing operation is performed at room temperature.

18. The method of claim 9, wherein after performing the pressing operation, the method further comprises:
performing a spraying operation to form a third insulating layer to cover the magnetic body; and
removing portions of the third insulating layer to expose the first outer protruding portion, the second outer protruding portion, the first inner protruding portion, and the second inner protruding portion in the mounting surface.
